(19) United States
(12) Patent Application Publication
(10) Pub. No.: US 2003/0007300 A1
(43) Pub. Date: Jan. 9, 2003

(54) Voltage controller

(76) Inventor: George Mazereeuw, Freckleton (GB)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/682,005

(22) Filed: Jul. 6, 2001

(51) Int. Cl. H02H 3/24

(52) U.S. Cl. 361/90

(57) ABSTRACT

A method for protecting an electrical device includes monitoring a line voltage to detect a high voltage condition such that the voltage is above a predetermined voltage range, and monitoring the line voltage to detect a low voltage condition such that the voltage is below the predetermined range. The method also includes electrically isolating the electrical device such that the electrical device does not receive electricity when at least one of a high voltage condition and a low voltage condition is detected.

### BACKGROUND OF INVENTION

This invention relates generally to electrical devices and, more particularly, to devices for protecting electrical equipment.

Many pieces of electrical equipment operate using line current supplied by a utility company over an electrical distribution network. Within some networks, the line voltage may fluctuate and cause damage to the electrical equipment. For example, exposure to large voltage fluctuations may damage electric motors, including refrigeration system compressors. One known technique employed to facilitate protecting electrical equipment from a high voltage spike involves installing surge protectors upstream from the equipment desired to be protected. Such surge protectors are usually selected to protect equipment from high voltage fluctuations. However, low voltage fluctuations may also damage some electrical devices.

### SUMMARY OF INVENTION

In one aspect, a method for protecting an electrical device is provided. The method includes monitoring a line voltage to detect a high voltage condition such that the voltage is above a predetermined voltage range, and monitoring the line voltage to detect a low voltage condition such that the voltage is below the predetermined range. The method also includes electrically isolating the electrical device such that the electrical device does not receive electricity when at least one of a high voltage condition and a low voltage condition is detected.

In another aspect, a circuit for protecting an electrical device is provided. The circuit is configured to monitor a line voltage to detect a voltage above a predetermined voltage range, and monitor the line voltage to detect a voltage below the predetermined range. The circuit is also configured to electrically isolate the electrical device such that the electrical device does not receive electricity when at least one of a voltage above the predetermined voltage range and a voltage below the predetermined range is detected.

In a further aspect, a circuit for protecting an electrical device is configured to monitor a line voltage to detect a high voltage condition such that the voltage is above a predetermined voltage range, and monitor the line voltage to detect a low voltage condition such that the voltage is below the predetermined range. The circuit is also configured to electrically isolate the electrical device such that the electrical device does not receive electricity when at least one of a high voltage condition and a low voltage condition is detected, and monitor the line voltage after electrically isolating the electrical device to detect a voltage within the predetermined range. The circuit is also configured to restore power to the electrical device when the line voltage is detected to be within the predetermined voltage range, and provide a visual indication when a low voltage condition is detected. The circuit is also configured to provide a visual indication when a high voltage condition is detected, and provide a visual indication when the line voltage is being tested.

### BRIEF DESCRIPTION OF DRAWINGS

FIG. 1 is a perspective view of an exemplary embodiment of a voltage controller.

FIG. 2 is a schematic of an exemplary embodiment of a circuit for the voltage controller shown in FIG. 1.

### DETAILED DESCRIPTION

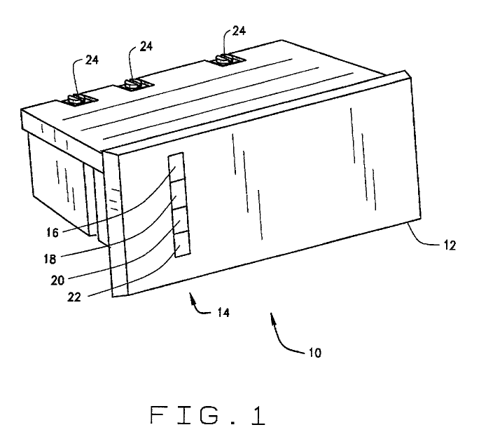

FIG. 1 is a perspective view of an exemplary embodiment of a voltage controller 10 including a front panel 12 and a plurality of light emitting diodes, LEDs, 14 attached to front panel 12. In an alternative embodiment, LEDs 14 are not attached to front panel 12 and are visible through front panel 12. In one embodiment, LEDs 14 are attached to a circuit board (not shown) and LEDs 14 extend from front panel 12. LEDs 14 include a first LED 16, a second LED 18, a third LED 20, and a fourth LED 22. Voltage controller 10 also includes a plurality of connection terminal blocks 24, and is interfaced between an electrical device (not shown) such as a motor, and at least one power line (not shown) electrically coupled to a power distribution network (not shown). Specifically, the motor and the power line are connected to connection terminal blocks 24, and, as explained below, voltage controller 10 controls whether or not the electrical device receives power.

During operation of voltage controller 10, under normal voltage operating conditions, first LED 16 is energized and produces a green light that provides a visual indication that the voltage supply is within a predetermined voltage range above and below a predetermined nominal voltage. In one embodiment, the predetermined range is approximately ten percent above and below the nominal voltage. For example, in a 220 volt environment, first LED 16 is energized when the voltage is between approximately 198 volts and approximately 242 volts. In another embodiment, the predetermined range is approximately fifteen percent above and below the nominal voltage of 220 and first LED 16 is energized when the voltage is between 187 volts and 253 volts. Second LED 18 is intermittently energized (blinks) to indicate that the line voltage is being tested. In one embodiment, when the line voltage is being tested, second LED 18 is energized and produces a green light which provides a visual indication of the line voltage testing. In an exemplary embodiment, the line voltage is tested continuously. In another embodiment, the line voltage is tested less than continuously. Additionally, when the voltage is outside the predetermined range, and approximately every one hundred sixty four seconds. In alternative embodiments, the voltage is tested between approximately every two to one hundred sixty four seconds.

When the voltage rises above the predetermined range, first LED 16 is de-energized and third LED 20 is energized and produces a yellow light which provides a visual indication of a high voltage condition. Additionally, when the voltage is above the predetermined range, voltage controller 10 electrically isolates the electrical device (e.g., a motor) from the line voltage to prevent the electrical device from receiving electricity. Voltage controller 10 continues to monitor the line voltage and when the voltage is decreased and returns within the predetermined range, voltage controller 10 restores power to the electrical device and third LED 20 is de-energized while first LED 16 is reenergized.

When the voltage is decreased below the predetermined range, first LED 16 is de-energized and fourth LED 22 is energized and produces a red light which provides a visual indication of a low voltage condition. Moreover, when the voltage is below the predetermined range, voltage controller 10 electrically isolates the electrical device from the line voltage to prevent the electrical device from receiving electricity. Voltage controller 10 continues to monitor the line voltage and when the voltage increases and returns within the predetermined range, voltage controller 10 restores power to the electrical device and fourth LED 22 is de-energized while first LED 16 is reenergized. In alternative embodiments, colors other than green, red, and yellow are utilized by LEDs 16, 18, 20, and 22 to provide visual indications of voltage within range, testing voltage, high voltage condition, and low voltage condition respectively.

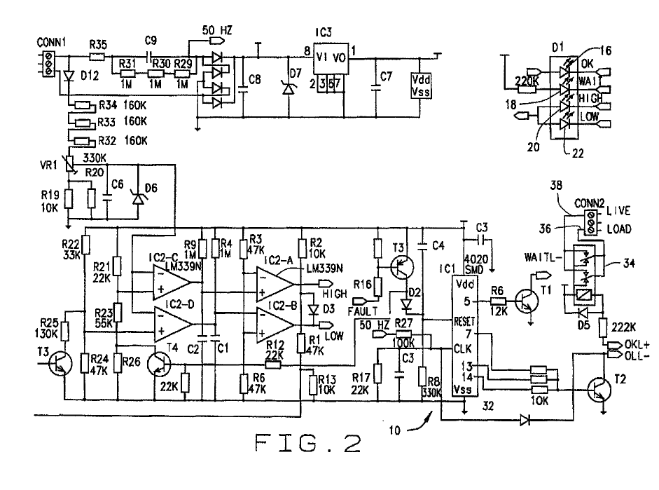

FIG. 2 is a schematic of an exemplary embodiment of a circuit 30 for voltage controller 10 (shown in FIG. 1). Circuit 30 is used to monitor a line voltage and to control whether an electrical device receives electrical power, as described above with respect to voltage controller 10. More specifically, circuit 30 includes an Integrated Circuit, IC, 32 coupled to one or more double-pole single-throw normally-open relays 34. Relay 34 is between a load lug 36 and a live lug 38 such that when relay 34 is closed, current may flow between live lug 38 and load lug 36, and when relay 34 is open, current is prevented from flowing between live lug 38 and load lug 36. IC 32 controls relay 34, and accordingly, controls whether an electrical device connected to load lug 36 via connection terminal 24 (shown in FIG. 1) receives electrical power. Circuit 30 also includes first LED 16, second LED 18, third LED 20, and fourth LED 22 which function as described above.

While the invention has been described in terms of various specific embodiments, those skilled in the art will recognize that the invention can be practiced with modification within the spirit and scope of the claims.

1. A method for protecting an electrical device, said method comprising the steps of:
monitoring a line voltage to detect a high voltage condition such that the voltage is above a predetermined voltage range;
monitoring the line voltage to detect a low voltage condition such that the voltage is below the predetermined range; and
electrically isolating the electrical device such that the electrical device does not receive electricity when at least one of a high voltage condition and a low voltage condition is detected.

2. A method according to claim 1 further comprising the step of monitoring the line voltage after electrically isolating the electrical device.

3. A method according to claim 2 further comprising the step of restoring power to the electrical device when the line voltage is within the predetermined voltage range.

4. A method according to claim 1 further comprising the step of providing a visual indication that the line voltage is being monitored.

5. A method according to claim 1 further comprising the step of providing a visual indication that a low voltage condition is detected.

6. A method according to claim 1 further comprising the steps of:
providing a visual indication when a low voltage condition is detected; and
providing a visual indication when a high voltage condition is detected.

7. A method according to claim 3 further comprising the step of providing a visual indication when a low voltage condition is detected.

8. A method according to claim 3 further comprising the steps of:
providing a visual indication when a low voltage condition is detected; and
providing a visual indication when a high voltage condition is detected.

9. A method according to claim 1 wherein said step of monitoring the line voltage comprises the step of providing a visual indication when the line voltage is being tested.

10. A circuit for protecting an electrical device, said circuit configured to:
monitor a line voltage to detect a voltage above a predetermined voltage range;
monitor the line voltage to detect a voltage below the predetermined range; and
electrically isolate the electrical device such that the electrical device does not receive electricity when at least one of a voltage above the predetermined voltage range and a voltage below the predetermined range is detected.

11. A circuit according to claim 10 further configured to monitor the line voltage after electrically isolating the electrical device.

12. A circuit according to claim 11 further configured to restore power to the electrical device when the line voltage is within the predetermined voltage range.

13. A circuit according to claim 10 further configured to provide a visual indication of the monitoring of the line voltage.

14. A circuit according to claim 10 further configured to provide a visual indication when a voltage below the predetermined voltage range is detected.

15. A circuit according to claim 10 further configured to:
provide a visual indication when a voltage below the predetermined voltage range is detected; and
provide a visual indication when a voltage above the predetermined voltage range is detected.

16. A circuit according to claim 12 further configured to provide a visual indication when a voltage below the predetermined voltage range is detected.

17. A circuit according to claim 12 further configured to:
provide a visual indication when a voltage below the predetermined voltage range is detected; and
provide a visual indication when a voltage above the predetermined voltage range is detected.

18. A circuit according to claim 10 further configured to provide a visual indication when the line voltage is being tested.

19. A circuit according to claim 17 further configured to provide a visual indication when the line voltage is being tested.

20. A circuit for protecting an electrical device, said circuit configured to:
monitor a line voltage to detect a high voltage condition such that the voltage is above a predetermined voltage range;
monitor the line voltage to detect a low voltage condition such that the voltage is below the predetermined range;
electrically isolate the electrical device such that the electrical device does not receive electricity when at least one of a high voltage condition and a low voltage condition is detected;
monitor the line voltage after electrically isolating the electrical device to detect a voltage within the predetermined range;
restore power to the electrical device when the line voltage is detected to be within the predetermined voltage range;
provide a visual indication when a low voltage condition is detected;
provide a visual indication when a high voltage condition is detected; and
provide a visual indication when the line voltage is being tested.
